(19) United States
(12) Patent Application Publication
(10) Pub. No.: US 2008/0262861 A1
(43) Pub. Date: Oct. 23, 2008

(54) USER IDENTIFICATION MANAGEMENT SYSTEM AND METHOD

(76) Inventors: James D. Episale, Binghamton, NY (US); Luella A. Korsky, Elmira, NY (US); Amy J. Snavely, Binghamton, NY (US)

Correspondence Address: HOFFMAN WARNICK LLC, 75 STATE ST, 14TH FLOOR, ALBANY, NY, 12207, US

(21) Appl. No.: 11/738,628

(22) Filed: Apr. 23, 2007

(51) Int. Cl. G06Q 10/00

(52) U.S. Cl. 705/1

(57) ABSTRACT

A method, system and computer program product for providing user identification to multiple destinations in a business transaction are disclosed. A user registers with a processing center and communicates a request for providing identification information to multiple destinations thereto. Identification message attributes required by each of the multiple destinations are determined, and user identification information is retrieved by the processing center. The user identification information is combined with the identification message attributes to generate identification messages to the respective destinations.

### FIELD OF THE INVENTION

The present invention relates in general to electronic business, and more particularly to managing and populating user identification information to multiple destinations.

### BACKGROUND OF THE INVENTION

In a typical electronic business (e-business) transaction, a transaction initiator, e.g., a buyer, may need to get access to resources of multiple suppliers. Traditionally, the buyer may have to obtain access to the supplier systems separately, by manually providing identification information to each of the multiple supplier systems under their own unique formats. Such manual inputs may make an e-business transaction very inconvenient such that the full potential of e-business cannot be achieved.

Based on the above, there is a need in the art for a new solution to manage and populate user identification information to multiple destinations.

### SUMMARY OF THE INVENTION

A method, system and computer program product for providing user identification to multiple destinations in a business transaction are disclosed. A user registers with a processing center and communicates a request for providing identification information to multiple destinations. Identification message attributes required by each of the multiple destinations are determined, and user identification information is retrieved by the processing center. The user identification information is combined with the identification message attributes to generate identification messages to the respective destinations.

A first aspect of the invention is directed to a method for providing user identification to a destination in a business transaction, the method comprising: determining an identification message attribute for the destination; retrieving user identification information for the destination; and generating a user identification message to the destination based on the identification message attribute and the user identification information.

A second aspect of the invention is directed to a system for providing user identification to a destination in a business transaction, the system comprising: means for determining an identification message attribute for the destination; means for retrieving user identification information for the destination; and means for generating a user identification message to the destination based on the identification message attribute and the user identification information.

A third aspect of the invention is directed to a computer program product comprising: computer usable program code which, when executed by a computer system, is configured to: determine an identification message attribute for a destination; retrieve user identification information for the destination; and generate a user identification message to the destination based on the identification message attribute and the user identification information.

A fourth aspect of the invention is directed to a method for deploying a system for providing user identification to a destination in a business transaction, the method comprising: providing a computer infrastructure being operable to: determine an identification message attribute for the destination; retrieve user identification information for the destination; and generate a user identification message to the destination based on the identification message attribute and the user identification information.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

The embodiments of this invention will be described in detail, with reference to the following figures, wherein like designations denote like elements, and wherein:

FIG. 1 shows a block diagram of a system according to an embodiment of the invention.

FIG. 2 shows a block diagram of an illustrative computer system according to an embodiment of the invention.

FIG. 3 shows an embodiment of the operation of an identification management system according to the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. System Overview

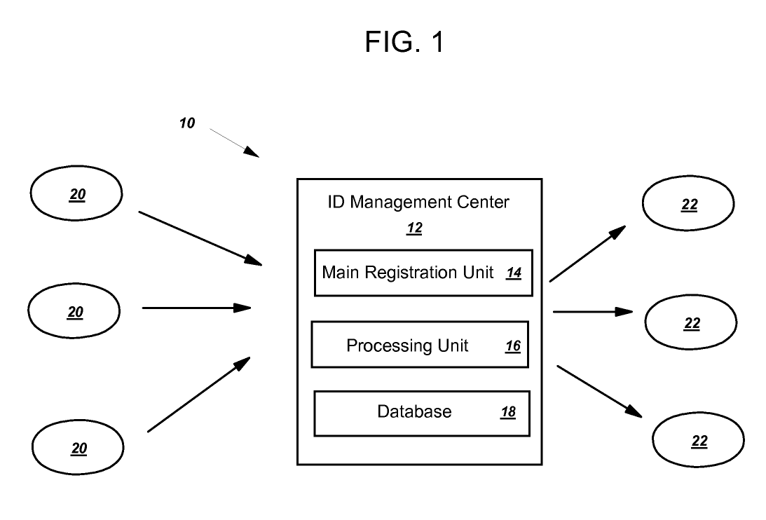

FIG. 1 shows a block diagram of a system 10 according to an embodiment of the invention. System 10 includes an identification (ID) management center 12. Identification management center 12 may be implemented by any system, e.g., an e-business server, that can perform the functions described below. According to an embodiment, ID management center 12 includes a main registration unit 14, a processing unit 16 and a database 18. ID management center 12 communicates to multiple users 20 and destination systems 22. In the current description, a user refers to anyone who/that requests an access to a destination system 22. In a typical e-business transaction, a user 20 may need to obtain accesses to more than one destination systems 22, and may need to provide identification information to the more than one destination systems 22. Typically, each destination system 22 may require different types of identification information and/or different contents of identification information. For example, a user 20 may register with different destination systems 22 using different user names and passwords. It should be appreciated that users 20 and destination systems 22 are used only for illustrative purposes and are differentiated only regarding a specific request for access. That is, a system that requests an access to another system is referred to as a user 20. A destination system 22 in one transaction may become a user 20 in another transaction, and vice versa. It should be appreciated that components of ID management center 12, e.g., database 18, may be located at separate physical locations.

In operation, ID management center 12 functions as a central processing site for providing identification information to multiple destination systems 22. According to an embodiment, user 20 registers with ID management center 12, and communicates to ID management center 12 that accesses to multiple destination systems 22 are desired, and that identification information of user 20 needs to be provided to the multiple destination systems 22. In the following description, such communication will be referred to as a “request to provide ID” or a “request”. If registration of user 20 with ID management center 12 is approved by main registration unit 14, the request will be processed by processing unit 16 to generate and provide ID information to the expected destination systems 22 according to the specific requirements of each of the destination systems 22. In generating the ID information for each destination systems 22, processing unit 16 may need to query database 18.

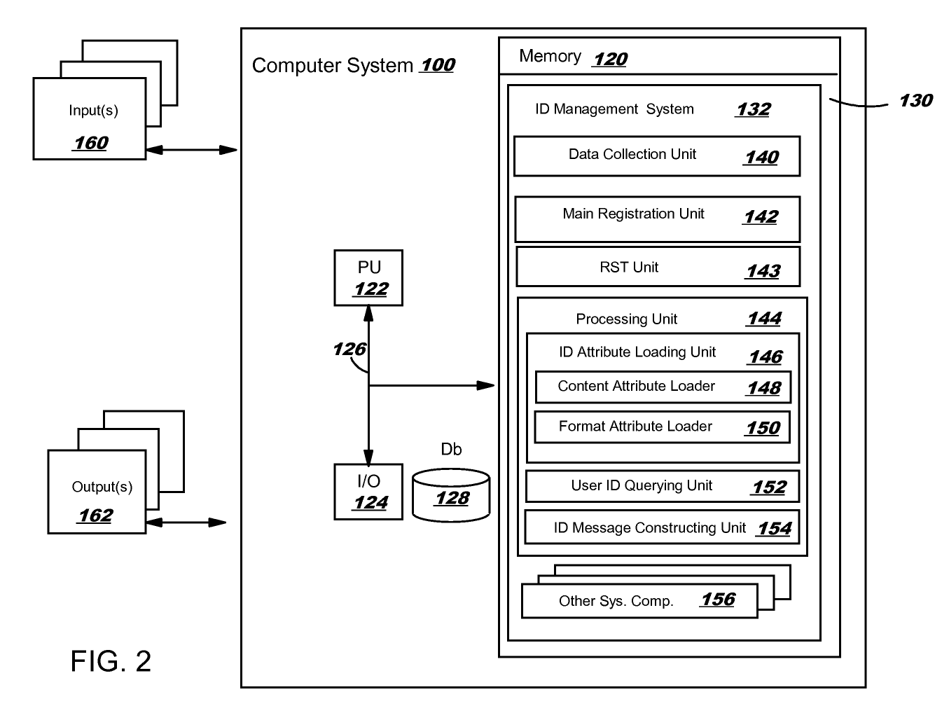

The functions of ID management center 12 may be wholly or partially implemented by a computer system 100 (FIG. 2), as will be described later.

### 2. Computer System

Referring to FIG. 2, a block diagram of an illustrative computer system 100 according to an embodiment of the invention is shown. In an embodiment, computer system 100 includes a memory 120, a processing unit (PU) 122, input/output devices (I/O) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data object, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 2, program product 130 may include an identification (ID) management system 132. ID management system 132 may function to implement ID management center 12 of FIG. 1. To this extent, ID management system 132 includes a data collection unit 140; a main registration unit 142; a registration status tracking (RST) unit 143; a processing unit 144; and other system components 156. Processing unit 144 includes an ID attribute loading unit 146 including a content attribute loader 148 and a format attribute loader 150, a user ID querying unit 152, and an ID message constructing unit 154. Other system components 156 may include any now known or later developed parts of a computer system 100 not individually delineated herein, but understood by those skilled in the art.

As discussed above, ID management system 132 may function to implement ID management center 12 of FIG. 1. To this extent, main registration unit 142, processing unit 144, and database 128 may implement main registration unit 14, processing unit 16, and database 18 of FIG. 1, respectively.

Inputs 160 to computer system 100 include, for example, requests communicated from users 20 (FIG. 1). Those inputs may be communicated to computer system 100 through I/O 124 and may be stored in memory 120 or database 128, and/or may be collected by data collection unit 140. Outputs 162 of computer system 100 include, for example, ID messages that may be communicated to destination systems 22 (FIG. 1). Outputs 162 may also include ID registration status information to be communicated to the respective user 20 (FIG. 1). The operation of ID management system 132 will be described in detail below.

### 3. Operation Methodology

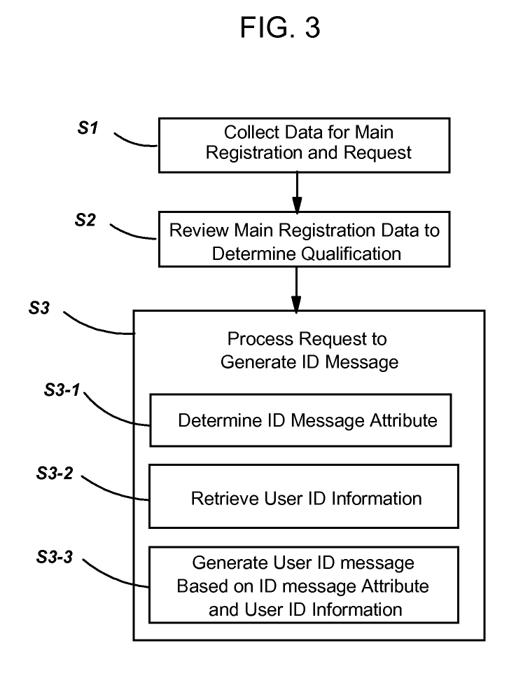

FIG. 3 shows an embodiment of the operation of ID management system 132. Referring now to FIGS. 2-3, in process S1, data collection unit 140 collects data for a main registration and a request communicated from a user 20 (FIG. 1). According to an embodiment, a request data string may indicate the destination systems 22 (FIG. 1) that are expected to be communicated with user ID information. The request may be in any format/protocol, and all are included in the invention.

In process S2, main registration unit 142 reviews the main registration information to determine whether the respective user 20 (FIG. 1) is qualified to use ID management system 132 to provide user ID information to destinations 22 (FIG. 1). Any standard may be used in the review and all are included in the invention. For example, main registration unit 142 may check whether the provided user name and password match one another as saved in database 128. If a user 20 (FIG. 1) is approved, a request from the user 20 will be queued to be processed by processing unit 144. If a user 20 (FIG. 1) is not approved, the user 20 will be so notified. Registration status tracking (RST) unit 143 functions to keep track of and update a status of a request in ID management system 132, and the updated status may be communicated to the respective user 20 (FIG. 1).

In process S3, processing unit 144 processes a request to generate ID messages to multiple destination system 22 (FIG. 1). Process S3 includes three sub-processes. In sub-process S3-1, ID attribute loading unit 146 determines/retrieves the required ID message attributes for a destination system 22 (FIG. 1). An ID message attribute may include any attribute required for an ID message communicated to a destination system 22 (FIG. 1). According to an embodiment, the ID message attributes include content attributes and format attributes. A content attribute refers to a type of ID information required by a destination system 22 (FIG. 1), for example, user name, password, social security number, date of birth, etc. A format attribute refers to a message format/protocol required by a destination system 22 (FIG. 1), for example, data structure, encryption, etc. According to an embodiment, the content attributes do not include the specific information regarding a user 20 (FIG. 1), but only include the type of identification information required. For example, user name as a type of information may be a content attribute, but the specific user name of a user 20 (FIG. 1) is not. According to an embodiment, content attribute loader 148 and format attribute loader 150 retrieve content attributes and format attributes, respectively, from database 128. The retrieved content attributes may be arranged in a table to facilitate combining user identification information with the respective content attributes. For example, user identification information for a specific user 20 (FIG. 1) may be inserted into the respective location of a content attribute in the table.

In sub-process S3-2, the user ID querying unit 152 retrieves user ID information regarding the respective user 20 (FIG. 1) for destination systems 22 (FIG. 1). It should be appreciated that user ID querying unit 152 may obtain the user ID information from any place or from user 20 (FIG. 1) through a GUI, and all are included in the invention. For example, the user ID information may be saved in database 128, and user ID querying unit 152 queries database 128 for the information. According to an embodiment, a user 20 may have different identification information for different destination systems 22 (FIG. 1), and user ID querying unit 152 retrieves the specific identification information of user 20 for a specific destination system 22. For example, a user 20 (FIG. 1) may have different user names and passwords for different destination systems 22 (FIG. 1). According to another embodiment, the user ID information for all destination systems 22 (FIG. 1) is the same, although different destination systems 22 may require different pieces (types) of information as defined in ID content attributes.

In sub-process S3-3, ID message constructor 154 generates an ID message to a destination system 22 (FIG. 1) based on the ID message attributes and user ID information. According to an embodiment, ID message constructor 154 combines the determined ID content attributes with the retrieved user ID information, and formats the ID message based on the determined format attributes for a destination system 22 (FIG. 1). According to an embodiment, the combination includes inserting the user ID information to the table of content attributes. For example, if a destination system 22 (FIG. 1) requires user name and password as content attributes of an ID message to it, ID message constructor 154 will insert the retrieved user name and password (specific for the specific destination system 22, FIG. 1) to fill these content attributes. According to an embodiment, sub-processes S3-1 and S3-3 are all performed within a single central processing cite, e.g., ID management center 12 (FIG. 1).

After the request has been processed to generate ID messages to be communicated to respective destination systems 22 (FIG. 1), registration status tracking (RST) unit 143 will update the status of the request to reflect this progress. Further, RST unit 143 may further keep track of the transmission, receipt, and approval of an ID message to the respective destination system 22 (FIG. 1).

Additional features of the current invention includes updating database 128 to reflect new destination systems 22 added to system 10 (FIG. 1), e.g., content attributes and format attributes required by the new destination system 22 (FIG. 1), and new user ID information.

### 4. Conclusion

While shown and described herein as a method and system for providing user identification to a destination in a business transaction, it is understood that the invention further provides various alternative embodiments. For example, in an embodiment, the invention provides a program product stored on a computer-readable medium, which when executed, enables a computer infrastructure to provide user identification to a destination in a business transaction. To this extent, the computer-readable medium includes program code, such as request processing system 132 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 2) and/or database 128 (FIG. 2), and/or as a data signal traveling over a network (e.g., during a wired/wireless electronic distribution of the program product).

In another embodiment, the invention provides a method of generating a system for providing user identification to a destination in a business transaction. In this case, a computer infrastructure, such as computer system 100 (FIG. 2), can be obtained (e.g., created, maintained, having been made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing system 100 (FIG. 2), from a computer-readable medium; (2) adding one or more computing devices to the computer infrastructure; and (3) incorporating and/or modifying one or more existing systems of the computer infrastructure to enable the computer infrastructure to perform the process steps of the invention.

In still another embodiment, the invention provides a business method that performs the process described herein on a subscription, advertising supported, and/or fee basis. That is, a service provider could offer to provide user identification to a destination in a business transaction as described herein. In this case, the service provider can manage (e.g., create, maintain, support, etc.) a computer infrastructure, such as computer system 100 (FIG. 2), that performs the process described herein for one or more customers and communicates the results to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for providing user identification to a destination in a business transaction, the method comprising:
determining an identification message attribute for the destination;
retrieving user identification information for the destination; and
generating a user identification message to the destination based on the identification message attribute and the user identification information.

2. The method of claim 1, wherein the identification message attribute includes a content attribute and a format attribute.

3. The method of claim 2, wherein the determined content attribute is arranged in a table.

4. The method of claim 2, wherein the generating includes combining the user identification information and the content attribute.

5. The method of claim 1, further comprising receiving a request from a user for providing identification to multiple destinations by a central processing site, the request indicating the multiple destinations.

6. The method of claim 5, wherein the determining and the generating are performed at the central processing site.

7. The method of claim 5, further comprising keeping track of a status of the request.

8. A system for providing user identification to a destination in a business transaction, the system comprising:
means for determining an identification message attribute for the destination;
means for retrieving user identification information for the destination; and
means for generating a user identification message to the destination based on the identification message attribute and the user identification information.

9. The system of claim 8, wherein the identification message attribute includes a content attribute and a format attribute.

10. The system of claim 9, wherein the determined content attribute is arranged in a table.

11. The system of claim 9, wherein the generating means includes means for combining the user identification information and the content attribute.

12. The system of claim 8, further comprising means at a central processing site for receiving a request from a user for providing identification to multiple destinations, the request indicating the multiple destinations.

13. The system of claim 12, wherein the determining and the generating means are located at the central processing site.

14. The system of claim 12, further comprising means for keeping track of a status of the request.

15. A computer program product comprising:
computer usable program code which, when executed by a computer system, is configured to:
determine an identification message attribute for a destination;
retrieve user identification information for the destination; and
generate a user identification message to the destination based on the identification message attribute and the user identification information.

16. The program product of claim 15, wherein the identification message attribute includes a content attribute and a format attribute.

17. The program product of claim 16, wherein the determined content attribute is arranged in a table.

18. The program product of claim 16, wherein the computer usable program code is further configured to combine the user identification information and the content attribute.

19. The program product of claim 15, wherein the computer usable program code is further configured to receive a request from a user for providing identification to multiple destinations, the request indicating the multiple destinations.

20. The program product of claim 19, wherein the computer usable program code is further configured to keep track of a status of the request.

21. A method for deploying a system for providing user identification to a destination in a business transaction, the method comprising:
providing a computer infrastructure being operable to:
determine an identification message attribute for the destination;
retrieve user identification information for the destination; and
generate a user identification message to the destination based on the identification message attribute and the user identification information.

22. The method of claim 21, wherein the identification message attribute includes a content attribute and a format attribute.

23. The method of claim 22, wherein the determined content attribute is arranged in a table.

24. The method of claim 22, wherein the computer infrastructure is further operable to combine the user identification information and the content attribute.

25. The method of claim 21, wherein the computer infrastructure is further operable to receive a request from a user for providing identification to multiple destinations, the request indicating the multiple destinations.

26. The method of claim 25, wherein the computer infrastructure is further operable to keep track of a status of the request.
